(19) United States
(12) Patent Application Publication
(10) Pub. No.: US 2010/0191467 A1
(43) Pub. Date: Jul. 29, 2010

(54) SYSTEM AND METHOD FOR GENERATING OBSTACLE POSITION INDICATOR ON AIRCRAFT DISPLAY DEVICE

(75) Inventors: John Anthony Wise, Glendale, AZ (US); Robert Brian Valimont, Glendale, AZ (US); John G. Suddreth, Cave Creek, AZ (US); Frank Cupero, Glendale, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/358,890

(22) Filed: Jan. 23, 2009

(51) Int. Cl. G08G 5/04

(52) U.S. Cl. 701/301

(57) ABSTRACT

A flight display system is provided for deployment on a host aircraft including at least one obstacle-tracking data source. In one embodiment, the flight display system includes a display device and a controller. The controller is configured to be coupled to the obstacle-tracking data source and to receive data therefrom indicating the current position of a navigational obstacle. The controller is operably coupled to the display device and is configured to generate thereon an obstacle position indicator (OPI) graphic indicating the current position of the navigational obstacle relative to the current field of view of the display device.

### STATEMENT REGARDING FEDERALLY SPONSORED RESEARCH OR DEVELOPMENT

This invention was made with Government support under Contract No. NNL06AA05B awarded by NASA Langley. The Government has certain rights in this invention.

### TECHNICAL FIELD

The present invention relates generally to aircraft display systems and, more particularly, to system and method for generating an obstacle (e.g., air traffic) position indicator on an aircraft display device, such as a head-worn display device.

### BACKGROUND

Currently, air traffic management (“ATM”) is largely overseen by personnel stationed within ground-based control facilities, such as air traffic controllers. For example, during the landing approach of an aircraft (referred to herein as the “host aircraft”), an air traffic controller may alert the host aircraft's flight crew to the location of one or more neighboring aircraft. Specifically, the air traffic controller may verbally inform the host aircraft's flight crew of the clock position of a neighboring aircraft relative to the host aircraft's current position, as well as whether the neighboring aircraft is flying at an altitude above or below the host aircraft. If, for example, the bird's eye position (i.e., latitudinal and longitudinal position) of the closest neighboring aircraft is directly in front of the host aircraft and if the neighboring aircraft is flying at an altitude below that of the host aircraft, the air traffic controller may verbally alert the host aircraft to air traffic at “12 o'clock, low.” If, instead, the bird's eye position of the neighboring aircraft is to the immediate right of the host aircraft and if the neighboring aircraft is flying at an altitude above the host aircraft's altitude, the air traffic controller may verbally alert the host aircraft to air traffic at “3 o'clock, high.” In certain instances, the air traffic controller may also provide additional air traffic information, such as the distance between the host aircraft and the neighboring aircraft.

In general, personnel-driven, ground-based control facilities, such as air traffic controllers, are able to provide pertinent air traffic information in a timely and effective manner. However, control facility-based ATM systems are limited in certain respects. Such ATM system may be relatively costly to establish and maintain. In addition, such control facility-based ATM system are inherently limited in the volume of air traffic that they are able to effectively manage during given time period. Indeed, it is estimated that the volume of air traffic will exceed the management capacity of control facility-based ATM systems in the near future. For these reasons, the United States has commenced the development and implementation of a modernized ATM system (commonly referred to as the “Next Generation Air Transportation System” or, more simply, “NextGen”) in which air traffic management is generally handled by individual flight crews utilizing data compiled from a constellation of computerized systems aboard satellites and neighboring aircraft. Europe has also begun the development and implementation of a similar program commonly referred to as the “Single European Sky ATM Research,” or “SESAR,” program.

Considering the above, it is desirable to provide a flight display system and method for alerting aircraft crew to nearby air traffic and other such navigational obstacles (e.g., mountain peaks) that overcomes the limitations associated with conventional control facility communication procedures. Ideally, such a flight display system and method would indicate the clock position of nearby navigational obstacles and, perhaps, provided other information regarding nearby obstacles (e.g., whether a neighboring aircraft is above or below the aircraft's current altitude, the accuracy with which a nearby obstacle's position is detected, time of closure between the host aircraft and the nearby obstacle, etc.) in a rapid and intuitive manner. Furthermore, in embodiments of the flight display system that include a head-worn display device, it would also be desirable for the display system to indicate the clock position of the neighboring aircraft relative to the display device's current field of view. Other desirable features and characteristics of the present invention will become apparent from the subsequent Detailed Description and the appended claims, taken in conjunction with the accompanying drawings and this Background.

### BRIEF SUMMARY

A flight display system is provided for deployment on a host aircraft including at least one obstacle-tracking data source. In one embodiment, the flight display system includes a display device and a controller. The controller is configured to be coupled to the obstacle-tracking data source and to receive data therefrom indicating the current position of a navigational obstacle. The controller is operably coupled to the display device and is configured to generate thereon an obstacle position indicator (OPI) graphic indicating the current position of the navigational obstacle relative to the current field of view of the display device.

A method is further provided for generating an obstacle position indicator (OPI) graphic on a head-up display (HUD) device deployed on a host aircraft, which is equipped with at least one obstacle-tracking data source. In one embodiment, the method includes the steps of: determining the position of a navigational obstacle based upon data received from the obstacle-tracking data source, and generating on the display screen of the HUD device an obstacle position indicator (OPI) graphic. The OPI graphic includes: (i) an elliptical segment, and (ii) a clock position marker cooperating with the elliptical segment to visually indicate the clock position of the navigational obstacle relative to the field of view through the display screen of the HUD device.

A program product is further provided for use in conjunction with an avionics display system deployed on a host aircraft and including a head-up display (HUD) device and at least one obstacle-tracking data source. In one embodiment, the program product includes an avionics display program adapted to: (i) determine the position of a navigational obstacle based upon data received from the obstacle-tracking data source, and (ii) generate on the display screen of the HUD device an obstacle position indicator (OPI) graphic. The OPI graphic includes an elliptical segment and a clock position marker cooperating with the elliptical segment to visually indicate the clock position of the navigational obstacle relative to the field of view through the display screen of the HUD device. Computer-readable media bears the avionics display program.

### BRIEF DESCRIPTION OF THE DRAWINGS

At least one example of the present invention will hereinafter be described in conjunction with the following figures, wherein like numerals denote like elements, and:

FIG. 1 is a functional block diagram of a flight display system and a number of obstacle-tracking data sources in accordance with an exemplary embodiment;

FIG. 2 is a plan view of a first exemplary obstacle positioning indicator (OPI) graphic that may be generated by the flight display system shown in FIG. 1;

FIGS. 3-14 are plan views of various flight scenarios illustrating different ways in which the flight display system shown in FIG. 1 may manipulate the appearance of the OPI graphic shown in FIG. 2 in accordance with various navigational parameters;

FIGS. 15 and 16 are plan views of a second exemplary OPI graphic that may be generated by the flight display system shown in FIG. 1; and

FIGS. 17 and 18 are plan views of third and fourth exemplary OPI graphics, respectively, that each may be generated by the flight display system shown in FIG. 1.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

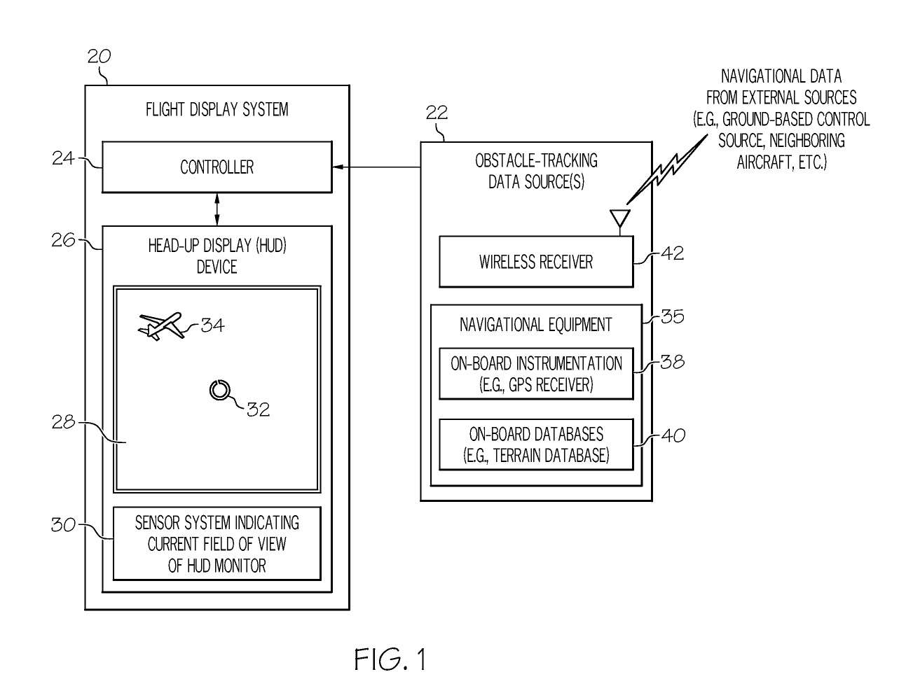

FIG. 1 is a simplified block diagram of an exemplary flight display system 20 suitable for deployment on an aircraft equipped with one or more obstacle-tracking data sources 22. Flight display system 20 includes a controller 24 and a display device 26, which is operatively coupled to controller 24. As indicated in FIG. 1, display device 26 is preferably a head-up display (HUD) device and will consequently be referred to as “head-up display device 26” or “HUD device 26” herein; however, it should be appreciated that display device 26 may assume the form of a head-down display device in alternative embodiments. HUD display device 26 includes a display screen 28, which may be partially transparent as described below. In a first group of embodiments, display screen 28 is rigidly mounted within the cockpit of an aircraft. In this case, the field of view (FOV) through display screen 28 remains fixed relative to the aircraft chassis or cockpit. However, in a second, preferred group of embodiments, display screen 28 assumes the form of a head-worn display (HWD) device (e.g., a helmet-mounted display device) that is worn by a member of the flight crew. In this second group of embodiments, the FOV through display screen 28 will vary in relation to the disposition of the crewmember's or wearer's head. To monitor the disposition of the wearer's head, and therefore the FOV through display screen 28, HUD display device 26 may be further equipped with a sensor system 30. During operation of flight display system 20, HUD display device 26 provides a signal to controller 24 indicative of the current disposition of display screen 28 as monitored by one or more sensors (e.g., a gyroscope, a tilt sensor, an accelerometer, etc.) included within sensor system 30.

During operation of flight display system 20, controller 24 drives HUD device 26 to generate an obstacle position indicator (OPI) graphic 32 on display screen 28 in accordance with data received from obstacle-tracking data sources 22 and, in certain embodiments, in accordance with data received from sensor system 30. As noted above, display screen 28 is preferably transparent or semi-transparent. This enables an aircraft crewmember to look through display screen 28 with minimal visual obstruction and observe the real-world environment beyond the aircraft's cockpit. OPI graphic 32 is thus effectively superimposed over the real-world view seen through display screen 28. Controller 24 may comprise any processing device suitable for generating OPI graphic 32 on display screen 28 in the manner described below. Specifically, controller 24 may comprise, or be associated with, any suitable number of individual microprocessors, memories, power supplies, storage devices, interface cards, and other standard components known in the art. Furthermore, controller 24 may include or cooperate with any number of software programs or instructions designed to carry out the various methods, process tasks, calculations, and control/display functions set-forth herein. In one embodiment, controller 24 assumes the form of a Flight Management Computer of the type commonly included within a Flight Management System (FMS).

Obstacle-tracking data sources 22 provide controller 24 with data indicative of the detected position of, and perhaps other information (e.g., the projected trajectory) relating to, one or more navigational obstacles within the general vicinity of the aircraft carrying flight display system 20 (“the host aircraft”). In general, these navigational obstacles will assume the form of air traffic; i.e., neighboring aircraft within the general vicinity of the host aircraft. However, obstacle-tracking data sources 22 may also provide data describing other navigational obstacles, such as a mountain peaks and other geographical features. In the illustrated exemplary embodiment, obstacle-tracking data sources 22 include one or more pieces of navigational equipment 35 onboard the host aircraft. Navigational equipment 35 may include various onboard instrumentation 38, such as a global position system (GPS) receiver, a radio altimeter, a barometric altimeter, and the like. Navigational equipment 35 may also include various onboard databases 40, such as a terrain database of the type commonly included within a Terrain Awareness and Warning System (TAWS).

In the exemplary embodiment illustrated in FIG. 1, obstacle-tracking data sources 22 further include a wireless transceiver or receiver 42 configured to receive navigational data from one or more external sources. The external sources from which wireless receiver 42 may receive navigational data include, but are not limited to, satellites and ground-based navigational facilities, such as Air Traffic Control Centers, Terminal Radar Approach Control Facilities, Flight Service Stations, and control towers. Wireless receiver 42 may also periodically receive Automatic Dependent Surveillance-Broadcast (ADS-B) data from neighboring aircraft. The ADS-B data may include, for example, state vectors pertaining to the neighboring aircraft. A particular state vector may be utilized to determine a neighboring aircraft's current position (e.g., latitude, longitude, and altitude) and, perhaps, the neighboring aircraft's projected flight path. As a still further example, wireless receiver 42 may periodically receive Traffic Information Services-Broadcast (TIS-B) data from ground stations or satellite reporting state vector data pertaining to aircraft lacking an ADS-B link.

As indicated in FIG. 1 and as discussed above, obstacle-tracking data sources 22 may receive, via wireless receiver 42, data from ground-based control facilities, such as air traffic controllers. This example notwithstanding, it is emphasized that flight display system 20 is particularly well-suited for use in conjunction with satellite- and aircraft-centric ATM programs, such as NextGen and SESAR. When employed with such satellite- and aircraft-centric ATM programs, obstacle-tracking data sources 22 may receive most, if not all, of external navigational data from computerized systems aboard other aircraft and satellite; thus, in such implementations, obstacle-tracking data sources 22 may receive little to no external navigational data from ground-based data sources.

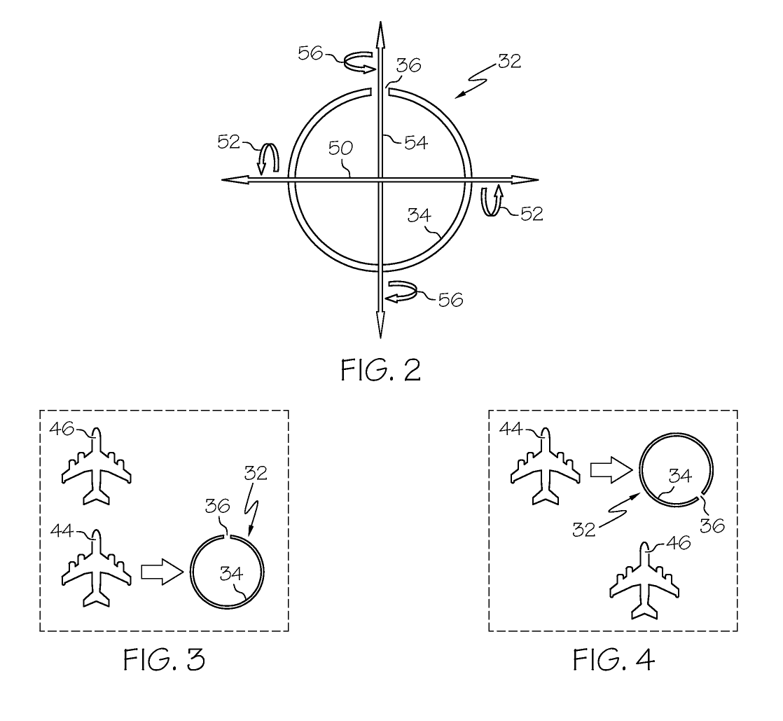

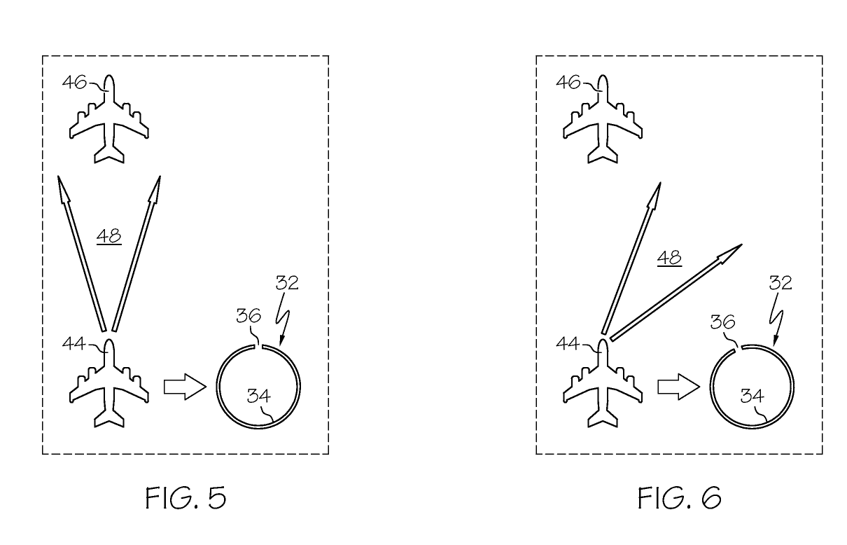

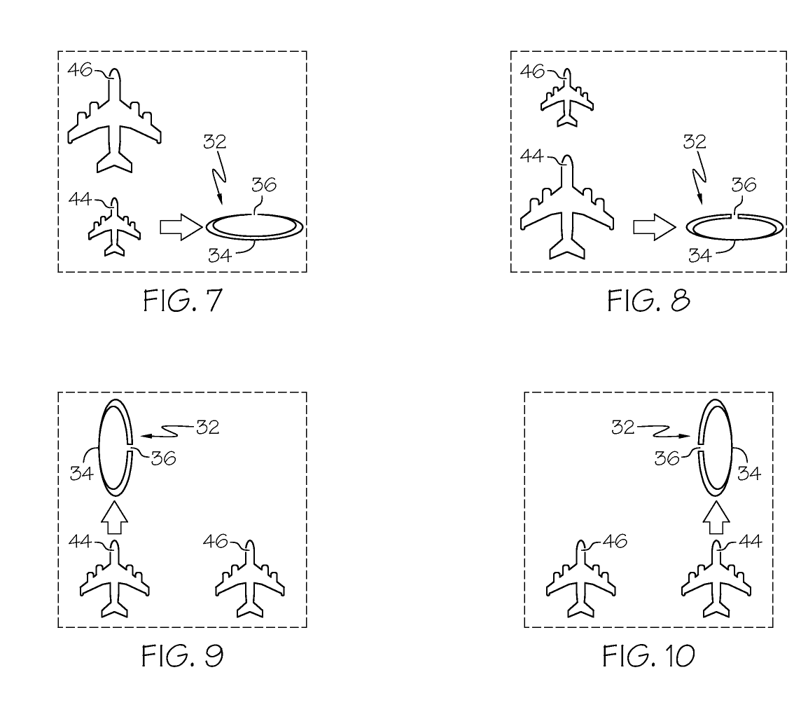

FIG. 2 is a plan view illustrating exemplary OPI graphic 32 in greater detail. As shown in FIG. 2, OPI graphic 32 comprises a ring 34, which is generally circular or elliptical, and a gap 36, which creates a visual break in ring 34. It may be noted that, in this particular example, OPI graphic 32 is similar in appearance to a Landolt ring traditionally utilized to determine visually acuity. The width or span of gap 36 may be predetermined. For example, the width of gap 36 may be determined to be approximately one arc minute, which is generally accepted as discernable by a viewer having normal (“20-20”) visual acuity. Alternatively, the width of gap 36 may be varied in relation to a chosen data characteristic, such as the accuracy with which data sources 22 are able to determine the location of a neighboring aircraft or other navigational obstacle as explained more fully below.

Controller 24 (FIG. 1) generates OPI graphic 32 such that the positioning of gap 36 is indicative of the clock position of a nearby obstacle (e.g., a neighboring aircraft). For this reason, gap 36 may be generically referred to as an “clock position marker.” FIGS. 3 and 4 illustrate OPI graphic 32 in first and second flight scenarios, respectively. In this particular set of examples, display screen 28 of HUD device 26 is fixedly mounted within the host aircraft's cockpit such that the field of view through display screen 28 is generally straight ahead of the cockpit. In the first flight scenario illustrated in FIG. 3, host aircraft 44 is flying immediately behind a neighboring aircraft 46. After receiving data from data sources 22 (FIG. 1) indicating this spatial relationship between aircraft 44 and 46, controller 24 (FIG. 1) has generated OPI graphic 32 on display screen 28 (FIG. 1) such that gap 36 is generally located at the 12 clock position. OPI graphic 32 thus visually conveys to a pilot or other crewmember that a neighboring obstacle 46 is detected directly in front of host aircraft 44. By comparison, in the second flight scenario illustrated in FIG. 4, controller 24 (FIG. 1) has generated OPI graphic 32 such that gap 36 is located at the 5 clock position. OPI graphic 32 thus visually conveys to a pilot or other crewmember that a neighboring obstacle 46 is detected to the rear right of aircraft 44. It should be noted that, in the flight scenarios illustrated in FIGS. 3 and 4, neighboring aircraft 46 is generally flying at the same general altitude as is host aircraft 44.

Notably, controller 24 (FIG. 1) is configured to position the clock position marker (e.g., gap 36) with respect to the field of view of display screen 28. Thus, in embodiments wherein HUD device 26 assumes the form of a head-worn display device and display screen 28 is worn by a member of the flight crew, the positioning of the clock position marker may not correspond to the neighboring obstacle's clock position with respect to the host aircraft. Further emphasizing this point, FIGS. 5 and 6 illustrate third and fourth flight scenarios, respectively, wherein HUD device 26 assumes the form of a head-worn display device and display screen 28 moves in conjunction with a wearer's head. In the third flight scenario (FIG. 5), the wearer is looking straight with respect to the cockpit of host aircraft 44. Data sources 22 (FIG. 1) indicate that neighboring aircraft 46 is centered with respect to the wearer's field of view through display screen 28 (FIG. 1), which is represented in FIG. 5 by the arrow-bounded region 48. Controller 24 (FIG. 1) thus generates OPI graphic 32 such that gap 36 is located at the 12 clock position. By comparison, in the fourth flight scenario (FIG. 6), the wearer has turned his or her head to the right and the field of view through display screen 28 (FIG. 1) has changed. Controller 24 (FIG. 1) consequently generates OPI graphic 32 such that gap 36 indicates the 11 clock position of neighboring aircraft 46 relative to the new field of view through display screen 28. By continually updating OPI graphic 32 in this manner, controller 24 (FIG. 1) provides an intuitive visual cue indicating the manner in which the wearer of HUD device 26 should turn his or her head to bring a neighboring obstacle into view. For example, and referring to the fourth flight scenario shown in FIG. 6, a crew member may determine from OPI graphic 32 that he or she need only turn his or her head a few degrees to the left to bring neighboring aircraft 46 into view.

It should thus be appreciated that OPI graphic 32 provides an aircraft crewmember with a visual indication of the clock position of a nearby obstacle (e.g., a neighboring aircraft) relative to the field of view through display screen 28 of HUD device 26 (FIG. 1), whether display screen 28 is fixed to relative to the aircraft's cockpit or relative to the head of a wearer. In certain embodiments, controller 24 (FIG. 1) may further be configured to alter the appearance OPI graphic 32 to indicate the altitude of neighboring aircraft 46 relative to the altitude of host aircraft 44. More specifically, controller 24 (FIG. 1) may visually rotate OPI graphic 32 about a first rotational axis 50 (labeled in FIG. 2) to indicate the altitude of neighboring aircraft 46 relative to the altitude of the host aircraft (indicated in FIG. 2 by arrow 52). The first rotational axis is preferably substantially parallel to the host aircraft's pitch axis. As a first example, and with reference to the flight scenario shown in FIG. 7, if obstacle-tracking data sources 22 (FIG. 1) indicate that neighboring aircraft 46 is flying at an altitude above that of host aircraft 44, controller 24 may rotate OPI graphic 32 about axis 50 (FIG. 2) in a first rotational direction. As indicated in FIG. 7, when OPI graphic 32 is rotated in this manner, the lower portion of OPI graphic 32 appears closer to the viewer than does the upper portion of OPI graphic 32. As a second example, and with reference to the flight scenario shown in FIG. 8, if neighboring aircraft 46 is flying at an altitude lower than that of host aircraft 44, controller 24 may rotate OPI graphic 32 about axis 50 in a second, opposing rotational direction. In this case, the upper portion of OPI graphic 32 appears to closer to the viewer than does the lower portion of OPI graphic 32. To facilitate viewer comprehension of the rotational orientation of OPI graphic 32, controller 24 may generate OPI graphic 32 in a perspective view. Thus, in the flight scenario illustrated in FIG. 7, controller 24 may generate OPI graphic 32 such that the lower portion of OPI graphic 32 appears to have a radial width larger than that of the upper portion of OPI graphic 32. Conversely, in the flight scenario illustrated in FIG. 8, controller 24 may generate OPI graphic 32 such that the upper portion of OPI graphic 32 appears to have a radial width larger than that of the lower portion of OPI graphic 32. Controller 24 may also be configured to render OPI graphic 32 in accordance with the origin of a virtual light source; e.g., if a virtual light source is positioned at noon (i.e., an upper center position), controller 24 may shade OPI graphic 32 such that the upper portion of OPI graphic 32 appears brighter than the lower portion of OPI graphic 32.

The angular displacement of OPI graphic 32 may generally correspond to the difference in altitude between neighboring aircraft 46 and host aircraft 44. Thus, if neighboring aircraft 46 is flying at, for example, 33,000 feet, while host aircraft is flying at 31,000 feet, the angular displacement of OPI graphic 32 may relatively small (e.g., approximately 20 degrees) relative to the nominal or “flat” position shown in FIG. 2. If, instead, neighboring aircraft 46 is flying at 39,000 feet, while host aircraft is flying at 31,000 feet, than the angular displacement of OPI graphic 32 may relatively large (e.g., approximately 80 degrees). By continually updating display screen 28 (FIG. 1) at a relatively rapid (e.g., “real time”) refresh rate such that OPI graphic 32 appears to rotate about rotational axis 50 (FIG. 2) in this manner, controller 24 may indicate the relative altitude of neighboring aircraft 46 in an intuitive manner. Furthermore, in embodiments of flight display system 20 wherein HUD device 26 assumes the form of a head-worn display device, the rotation of OPI graphic 32 may intuitively indicate the manner in which the crewmember wearing display screen 28 should tilt his or her head to bring neighboring aircraft 46 into view.

If desired, controller 24 (FIG. 1) may also be configured to rotate OPI graphic 32 about a second rotational axis 54 (represented in FIG. 2 by arrows 56) to further indicate the clock position of neighboring aircraft 46 or other navigational obstacle. Rotational axis 54 is preferably substantially perpendicular to rotational axis 50 and may be substantially parallel with the host aircraft's yaw axis. For example, in the flight scenario illustrated in FIG. 9, neighboring aircraft 46 resides at the 3 clock position with respect to host aircraft 44 and, more specifically, with respect to the field of view of display screen 28 (FIG. 1). Thus, controller 24 (FIG. 1) has visually rotated OPI graphic 32 about rotational axis 54 in a first direction. By comparison, in the flight scenario illustrated in FIG. 10, neighboring aircraft 46 resides at the 9 clock position with respect to the field of view of display screen 28 (FIG. 1). Thus, controller 24 (FIG. 1) has visually rotated OPI graphic 32 about rotational axis 54 in a second, opposing direction. In alternative embodiments, controller 24 (FIG. 1) may rotate OPI graphic 32 about rotational axis 54 (FIG. 2) to indicate other data parameters; e.g., the lateral distance between host aircraft 44 and neighboring aircraft 46. In still further embodiments, controller 24 (FIG. 1) may be configured to visually rotate OPI graphic 32 about axes 50 and 54 (FIG. 2) to indicate the clock position of navigational obstacles and thereby eliminate the need for a clock position marker, such as gap 36.

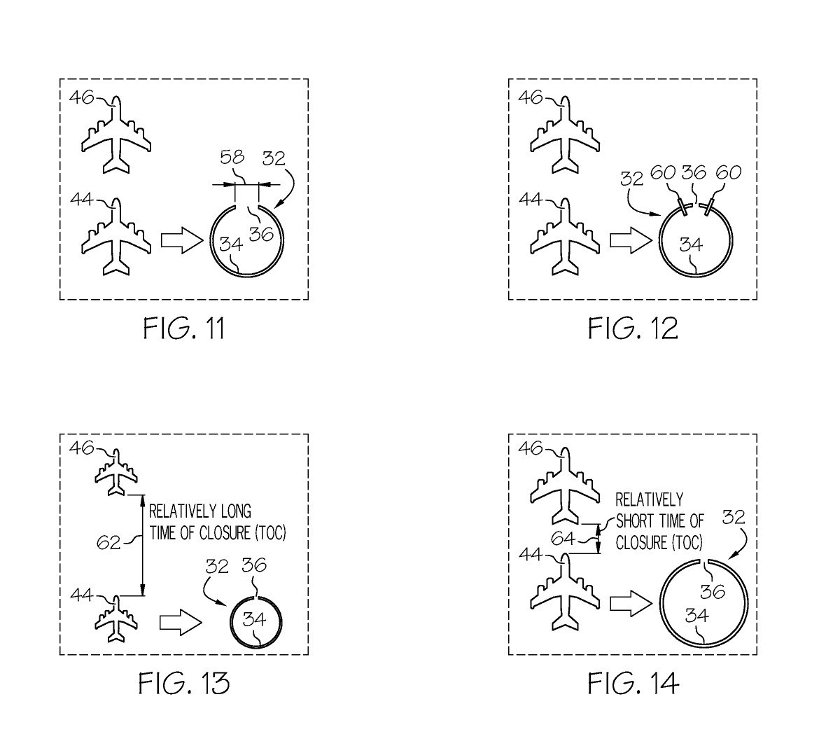

Controller 24 (FIG. 1) may alter the appearance of OPI graphic 32 to reflect the value of an error characteristic assigned to obstacle-tracking data sources 22. Controller 24 may assign an error characteristic to the relevant data source by recalling (e.g., from a memory included within controller 24) an error characteristic associated with the relevant position-determining data source. For example, if controller 24 utilizes data provided by a GPS receiver to determine the neighboring aircraft's position with respect to the host aircraft's current position, controller 24 may utilize a two-dimensional lookup table to recall a pre-determined error characteristic associated with a GPS receiver (e.g., ±100 vertical feet and ±50 horizontal feet). Notably, this pre-determined error characteristic may be adjusted in relation to external criteria. For example, the error characteristic associated with the GPS receiver may be adjusted in relation to the number of available satellites, the positioning of available satellites, weather conditions (e.g., humidity), and other such criteria. Data indicative of an error characteristic may also be included with the information wirelessly provided to controller 24 via an external data source, such as an air traffic controller. After attributing an error characteristic to obstacle-tracking data sources 22, controller 24 alters the visual appearance of OPI graphic 32 accordingly. For example, and as indicated in FIG. 11 by double-headed arrow 58, controller 24 (FIG. 1) may increase or decrease the span of gap 36 as the error characteristic increases or decreases in value, respectively. Alternatively, as indicated in FIG. 12 at 60, controller 24 (FIG. 1) may position hatch marks on either side of gap 36 such that the hatch marks reside closer to gap 36 when the error characteristic is relatively low and further from gap 36 when the error characteristic is relatively high.

In still further embodiments, controller 24 (FIG. 1) may alter the appearance of OPI graphic 32 to reflect the time of closure (TOC) between host aircraft 44 and a nearby obstacle. For example, controller 24 (FIG. 1) may adjust the scale of OPI graphic 32, with a predetermined range, to indicate the TOC between host aircraft 44 and neighboring aircraft 46. This may be appreciated by referring to FIGS. 13 and 14, which illustrate first and second additional flight scenarios wherein the TOC between host aircraft 44 and neighboring aircraft 46 is relatively long and relatively short, respectively. As indicated in FIG. 13, controller 24 (FIG. 1) may down scale OPI graphic 32 when the TOC between neighboring aircraft 46 and host aircraft 44 is relatively lengthy (represented in FIG. 13 by arrow 62); and, as indicated in FIG. 14, controller 24 (FIG. 1) may up scale OPI graphic 32 when the TOC between neighboring aircraft 46 and host aircraft 44 is relatively short (indicated in FIG. 13 by arrow 64).

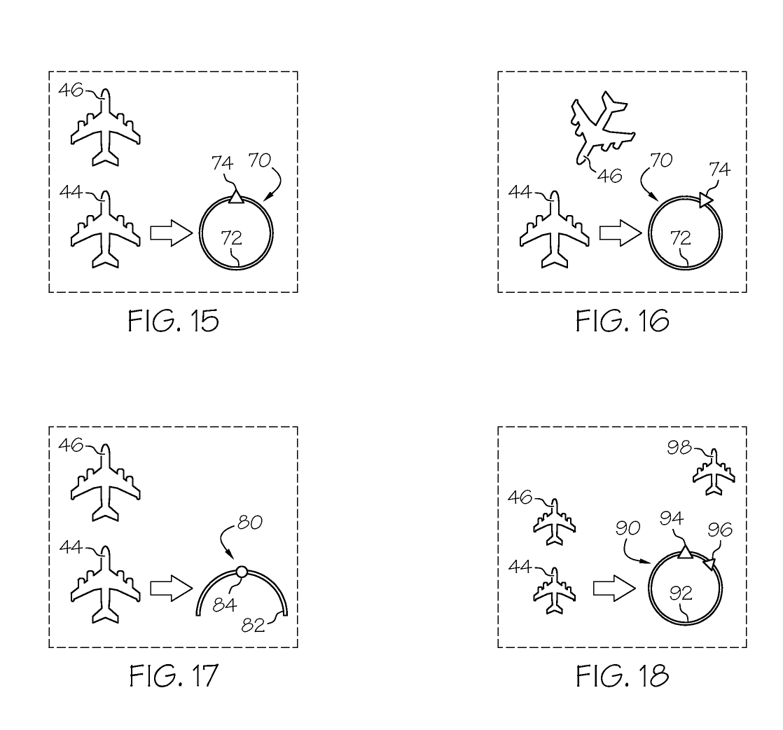

FIGS. 15 and 16 illustrate a second exemplary obstacle position indicating (OPI) graphic 70 in first and second additional flight scenarios, respectively. In many respects, OPI graphic 70 is similar to OPI graphic 32 discussed above in conjunction with FIGS. 3-14. As does OPI graphic 32, OPI graphic 70 includes a ring 72 and a clock position marker. However, in contrast to OPI graphic 32, clock position marker of OPI graphic 70 assumes the form of an arrow symbol 74. Arrow symbol 74 not only indicates the clock position of nearby obstacle, but also indicates whether the obstacle's trajectory is generally headed toward or away from host aircraft 44. For example, in the flight scenario illustrated in FIG. 15, arrow symbol 74 is at the 12 clock position and generally points away from ring 72. Arrow symbol 74 thus indicates that neighboring aircraft 46 is at the 12 clock position with respect to the field of view of display screen 28 (FIG. 1) and that the trajectory of neighboring aircraft 46 is generally headed away from neighboring aircraft 46. In the flight scenario illustrated in FIG. 16, arrow symbol 74 is at the 1 clock position and generally points toward the center of ring 72. Arrow symbol 74 thus indicates that neighboring aircraft 46 is at the 1 clock position with respect to the field of view of display screen 28 (FIG. 1) and that the trajectory of neighboring aircraft 46 is generally headed toward neighboring aircraft 46.

FIG. 17 illustrate a third exemplary obstacle position indicating (OPI) graphic 80. In this example, OPI graphic 80 comprises an elliptical (e.g., circular) segment 82 and a clock position marker 84. Elliptical segment 82 assumes the form of a 180° arc generally spanning from the 9 clock position to the 3 clock position. Accordingly, OPI graphic 70 visually indicates the position of navigational obstacles residing between 9 o'clock and 3 o'clock. OPI graphic 80 is thus well-suited for embodiments wherein display screen 28 of HUD device 26 (FIG. 1) is fixed relative to the cockpit of a host commercial or civilian aircraft, which is unlikely to be overtaken by a neighboring aircraft to the host aircraft's rear. However, in implementations wherein the host aircraft is a military aircraft and thus more likely to be overtaken by a neighboring aircraft (e.g., a fighter jet), and also in implementations wherein display screen 28 (FIG. 1) is fixed with respect to a crewmember's head, it is generally preferred that OPI graphic 70 includes a complete circular or elliptical ring, such as rings 34 and 72 described above in conjunction with FIGS. 3-16. As a point of emphasis, in embodiments wherein the obstacle position indicator graphic includes a complete circular or elliptical ring, the complete circular or elliptical ring still comprises an elliptical segment. For this reason, it may be stated that OPI graphic 32 shown in FIGS. 2-14 and that OPI graphic 70 shown FIGS. 15 and 16 each comprise an elliptical segment.

The obstacle position indicator graphic may indicate the position of multiple obstacles at a given time. Further illustrating this point, FIG. 18 is a plan view depicting an exemplary OPI graphic 90 including a ring 92, a first clock position marker 92, and a second clock position marker 94. As can be seen in FIG. 18, first clock position marker 92 indicates the clock position of a first neighboring aircraft 46; and second clock position marker 94 indicates the clock position of a second neighboring aircraft 98. If desired, controller 24 (FIG. 1) may alter the appearance of first and second clock position markers 92 and 94 to indicate the priority of the navigational obstacles corresponding thereto. For example, if display screen 28 is polychromatic, controller 24 (FIG. 1) may color code position marker 94 with a first high priority warning color (e.g., red) to indicate the relatively close proximity or the relatively short time of closure between neighboring aircraft 46 to host aircraft 44; and color code position marker 94 with a second low priority warning color (e.g., yellow or blue) to indicate the relatively distant proximity or relatively long time of closure between neighboring aircraft 98 and host aircraft 44. Alternatively, and as shown in FIG. 18, controller 24 (FIG. 1) may alter the size of position markers 94 and 96 in accordance with the priority of neighboring aircraft 46 and 98, respectively.

The foregoing has thus provided multiple examples of an obstacle position indicator graphic that may be generated on an aircraft display, such as a head-worn display device, by a controller included within a flight display system. At minimum, the OPI graphic provides an aircraft crewmember with an intuitive visual indication of the clock position of a nearby obstacle (e.g., a neighboring aircraft) relative to the field of view through a display screen, which may be fixed to relative to the aircraft's cockpit or relative to the head of a crewmember. The OPI graphic may also indicate other information pertaining to the navigational obstacle, such as the obstacle's altitude relative to the host aircraft and/or the obstacle's trajectory. Embodiments of the flight display system may be utilized in place of, or to reinforce, the verbal alerts traditionally provided by a ground-based control facilities. By generating the OPI graphic in the above-described manner, embodiments of the flight display system increase flight crew situation awareness and aid in the construction of mental models describing the airspace and the navigational obstacles surrounding aircraft. In addition, when produced on head-up display device, such as HUD device 26 (FIG. 1), the OPI graphic may help maintain a crew member's focal point near optical infinity and thereby increase the speed and accuracy with which the crew member may visually ascertain nearby navigational obstacles.

While the foregoing exemplary embodiment was described above in the context of a fully functioning computer system (i.e., flight display system 20 shown in FIG. 1), those skilled in the art will recognize that the mechanisms of the present invention are capable of being distributed as a program product (i.e., an avionics display program) and, furthermore, that the teachings of the present invention apply to the program product regardless of the particular type of computer-readable media (e.g., floppy disc, hard drive, memory card, optical disc, etc.) employed to carry-out its distribution. In addition, embodiments of the present invention may be described in terms of a method or process carried-out by a processing device, such as controller 24 shown in FIG. 1.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended Claims.

What is claimed is:

1. A flight display system for deployment on a host aircraft including at least one obstacle-tracking data source, the flight display system comprising:
a display device; and
a controller configured to be coupled to the obstacle-tracking data source and to receive data therefrom indicating the current position of a navigational obstacle, the controller operably coupled to the display device and configured to generate thereon an obstacle position indicator (OPI) graphic indicating the current position of the navigational obstacle relative to the current field of view of the display device.

2. A flight display system according to claim 1 wherein the OPI graphic comprises an elliptical segment.

3. A flight display system according to claim 2 wherein the OPI graphic further comprises a clock position marker indicating the clock position of the navigational obstacle relative to the display device's current field of view.

4. A flight display system according to claim 3 wherein the elliptical segment comprises a substantially complete ring.

5. A flight display system according to claim 2 wherein the clock position marker creates a visual break in the elliptical segment.

6. A flight display system according to claim 5 wherein the clock position marker comprises a gap in the elliptical segment.

7. A flight display system according to claim 2 wherein the clock position marker comprises an arrow symbol.

8. A flight display system according to claim 7 wherein the controller is further configured to: (i) receive from the obstacle-tracking data source data indicating the navigational obstacle's trajectory, and (ii) cause the arrow symbol to point generally toward or away from the center of the elliptical segment if the data indicates that the navigational obstacle's trajectory is headed toward or away from the host aircraft, respectively.

9. A flight display system according to claim 2 wherein controller is further configured to: (i) assign an error characteristic to the data provided by the obstacle-tracking data source, and (ii) alter the appearance of the clock position marker to indicate the value of the error characteristic.

10. A flight display system according to claim 9 wherein the clock position marker comprises a gap creates a visual break in the elliptical segment, and wherein the controller is configured to increase the span of the gap as the error characteristic increases in value.

11. A flight display system according to claim 2 wherein the controller is further configured to: (i) receive data from the obstacle-tracking data source indicative of time of closure required for the host aircraft to reach the navigational obstacle, and (ii) adjust the scale of the elliptical segment to indicate the time of closure.

12. A flight display system according to claim 2 wherein the display device comprises a head-worn display device, comprising:
a display screen that is at least partially transparent; and
a sensor system operably coupled to the controller and configured to monitor the orientation of, and thus the field of view through, the display screen.

13. A flight display system according to claim 2 wherein the controller is configured to rotate the elliptical segment about a first rotational axis: (i) in a first direction when the obstacle-tracking data source indicates that the navigational obstacle is above the altitude at which the host aircraft is currently flying, and (ii) in a second opposing direction when the obstacle-tracking data source indicates that the navigational obstacle is to the left of the field of view through the display screen

14. A flight display system according to claim 13 wherein the first rotational axis is substantially parallel to the host aircraft's pitch axis.

15. A flight display system according to claim 1 wherein the controller is further configured to: (i) receive from the obstacle-tracking data source data indicative of the time of closure between the navigational obstacle and the host aircraft, and (ii) adjust the scale of the OPI graphic in accordance with the time of closure.

16. A method for generating an obstacle position indicator (OPI) graphic on a head-up display (HUD) device deployed on a host aircraft, the aircraft equipped with at least one obstacle-tracking data source, the method comprising:
determining the position of a navigational obstacle based upon data received from the obstacle-tracking data source; and
generating on the display screen of the HUD device an obstacle position indicator (OPI) graphic comprising: (i) an elliptical segment, and (ii) a clock position marker cooperating with the elliptical segment to visually indicate the clock position of the navigational obstacle relative to the field of view through the display screen of the HUD device.

17. A method according to claim 16 further comprising:
receiving data from the obstacle-tracking data source indicative of the time of closure between the host aircraft and the navigational obstacle; and
alerting the appearance of the OPI graphic to indicate the time of closure.

18. A method according to claim 16 further comprising:
attributing an error characteristic to the obstacle-tracking data source; and
alerting the appearance of the OPI graphic in accordance with the assigned error characteristic.

19. A method according to claim 16 further comprising:
receiving data from the obstacle-tracking data source indicative of the trajectory of the navigational obstacle; and
alerting the appearance of the OPI graphic to indicate the trajectory of the navigational obstacle with respect to the host aircraft.

20. A program product for use in conjunction with an avionics display system deployed on a host aircraft and including a head-up display (HUD) device and at least one obstacle-tracking data source, the program product comprising:
an avionics display program adapted to:
determine the position of a navigational obstacle based upon data received from the obstacle-tracking data source; and
generate on the display screen of the HUD device an obstacle position indicator (OPI) graphic, the OPI graphic comprising:
an elliptical segment; and
a clock position marker cooperating with the elliptical segment to visually indicate the clock position of the navigational obstacle relative to the field of view through the display screen of the HUD device; and
computer-readable media bearing the avionics display program.
